(19) United States
(12) Patent Application Publication
(10) Pub. No.: US 2014/0286252 A1
(43) Pub. Date: Sep. 25, 2014

(54) WIRELESS TRANSMISSION MODULE HAVING MULTI-TRANSMISSION CHANNELS

(71) Applicant: Nai-Chien CHANG, New Taipei City (TW)

(72) Inventor: Nai-Chien CHANG, New Taipei City (TW)

(21) Appl. No.: 14/219,455

(22) Filed: Mar. 19, 2014

(30) Foreign Application Priority Data
Mar. 25, 2013 (TW) 102205468

(51) Int. Cl. H04B 1/03; H04B 1/04

(52) U.S. Cl. CPC H04B 1/03; H04B 1/04
USPC 370/329

(57) ABSTRACT

A wireless transmission module having multi-transmission channels includes a circuit board, at least one wireless transmission IC, a USB3.0 control IC and a transmission port. The wireless transmission IC, the USB3.0 control IC and the transmission port are connected with each other through the circuit board. The wireless transmission IC transmits and receives different wireless signal through different frequencies. The different wireless signal are integrated by the USB3.0 control IC, and being outputted externally through the transmission port after the integration. An electronic device connects with the wireless transmission module through the single transmission port, and the electronic device can use a plurality of wireless transmission channels of the wireless transmission module, so as to raise the transmission rate, or to reach the purpose of multi-transmission capability.

### BACKGROUND OF THE INVENTION

1. Field of the Invention

The present invention relates to a transmission module, and in particular to a wireless transmission module having multi-transmission channels.

2. Description of Prior Art

These years, the development of network technology is fast, almost any types of electronic device are built-in network capability for achieving the convenience of transmitting command and data via internet.

For expanding network functions on an electronic device lacking built-in network function, a very simple way is to arrange a wireless transmission module on the electronic device. The so called wireless transmission module has the capability of receiving, transmitting, and processing wireless signal. The wireless transmission module connects with the electronic device by way of physical interface, and transmits the received wireless signal to the electronic device after processing. Else, the wireless transmission module also receives signal from the electronic device, and output externally and wirelessly after processing.

Generally, most of the present wireless transmission modules in the market use a wireless transmission IC which adopts 802.11n standard, and use USB20. Interface for physically connecting with the electronic device. The normal transmission speed of the 802.11n standard is 300 Mbps, and the normal transmission speed of the USB2.0 interface is 480 Mbps. Obviously, the USB2.0 interface can fully support the transmission speed of the wireless transmission IC adopted the 802.11n standard, and the transmitted data will not be delayed.

However, the transmission speed of the USB2.0 interface is not as fast as twice of the transmission speed of the 802.11n standard, so, if the wireless transmission module arranges two or more than two wireless transmission ICs thereon, the total transmission speed of the wireless transmission module will be limited in 480 Mbps of transmission speed of the USB2.0 interface.

Furthermore, a new 802.11 ac standard is published recently, and the normal transmission speed of the 802.11ac standard is 867 Mpbs. Obviously, the transmission speed of the 802.11ac standard can't be fully supported by the USB2.0 interface. For instance, if the wireless transmission module receives signal wirelessly in 867 Mbps supported by the 802.11ac standard and can only transmit the received signal to the electronic device in 480 Mbps supported by the USB2.0 interface, the delay of the transmitted signal will occur. For the result, using the USB2.0 interface as the physical transmission interface between the wireless transmission module and the electronic device can't satisfy the user demand.

### SUMMARY OF THE INVENTION

The present invention is to provide a wireless transmission module having multi-transmission channels, which can raise transmission rate or accomplish multi-transmission capability by way of a plurality of wireless transmission channels.

A wireless transmission module having multi-transmission channel of this invention includes a circuit board, at least one wireless transmission IC, a USB3.0 control IC and a transmission port. The wireless transmission IC, the USB3.0 control IC and the transmission port are connected to each other through the circuit board. The wireless transmission IC transmits and receives different wireless signal through different frequencies. The different wireless signal are integrated by the USB3.0 control IC, and being outputted externally by the transmission port after the integration. An electronic device connects the wireless transmission module through the single transmission port, and the electronic device can use a plurality of wireless transmission channels of the wireless transmission module.

The highest transmission rate of USB3.0 interface is 5 Gbps, so the USB3.0 control IC of the present invention can support multiple wireless transmission ICs at the same time. In other hands, the USB3.0 control IC can support an integrated wireless transmission IC. An electronic device connects with the wireless transmission module of the present invention can transmit/receive wireless signal by way of multiple wireless transmission channels at the same time, so as to raise transmission rate. Else, the electronic device can also transmit different wireless signal by way of different wireless transmission channels separately, so as to reach the purpose of multi-transmission capability.

Moreover, the highest transmission rate of USB3.0 interface is higher than that of 802.11ac standard, so the wireless transmission module of the present invention can use USB3.0 interface to fully support the wireless transmission IC adopted with the 802.11ac standard. Therefore, the present invention solves the problem that the transmission rate of the wireless transmission IC adopted with the 802.11ac standard being limited by slower transmission rate of a USB2.0 interface used in a traditional wireless module.

### BRIEF DESCRIPTION OF THE DRAWINGS

FIG. 1 is an exploded perspective view of a first embodiment according to the present invention.

FIG. 2 is a combination perspective view of the first embodiment according to the present invention.

FIG. 3 is a block diagram of the first embodiment according to the present invention.

FIG. 4 is a block diagram of a second embodiment according to the present invention.

FIG. 5 is a perspective view showing a connection of a third embodiment according to the present invention.

FIG. 6 is a perspective view showing a connection of a fourth embodiment according to the present invention.

FIG. 7 is a perspective view showing a connection of a fifth embodiment according to the present invention.

FIG. 8 is a perspective view showing a connection of a sixth embodiment according to the present invention.

FIG. 9 is a side view of a seventh embodiment according to the present invention.

FIG. 10 is a combination perspective view of an eighth embodiment according to the present invention.

FIG. 11 is a block diagram of a ninth embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

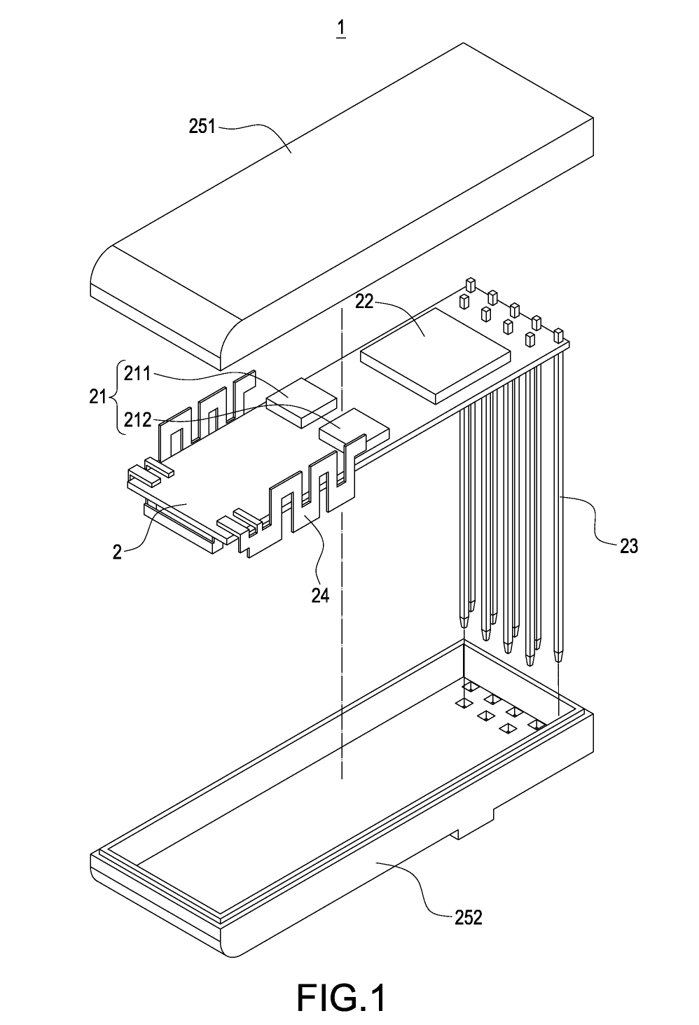

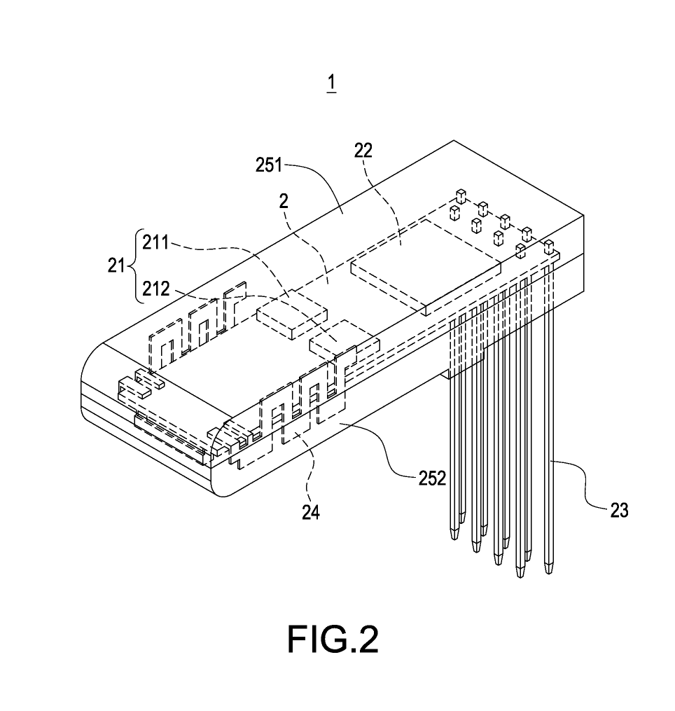

FIG. 1 is an exploded perspective view of a first embodiment according to the present invention. FIG. 2 is a combination perspective view of the first embodiment according to the present invention. The disclosure in FIG. 1 and FIG. 2 is a wireless transmission module 1 having multi-transmission channels (referred to as the module 1 hereinafter).

The module 1 mainly includes a circuit board 2, a plurality of wireless transmission integrated circuits (ICs) 21, a USB3.0 control integrated circuit (IC) 22, a transmission port 23, and a transmission antenna 24. The plurality of wireless transmission ICs 21, the USB3.0 control IC 22, the transmission port 23 and the transmission antenna 24 are electrically connected to the circuit board 2 separately.

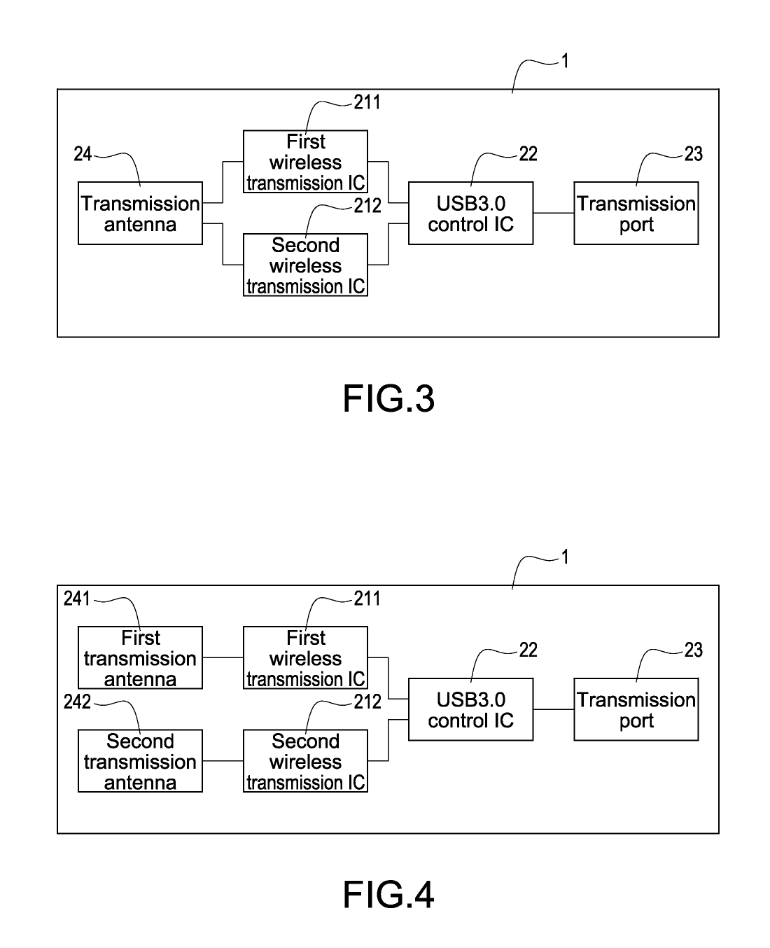

FIG. 3 is a block diagram of the first embodiment according to the present invention. In FIG. 3, the plurality of wireless transmission ICs 21 is depicted as a first wireless transmission IC 211 and a second wireless transmission IC 212. The amount of the plurality of wireless transmission ICs 21 is two in this embodiment, but not intended to limit the scope of the present invention.

The two wireless transmission ICs 21 in this embodiment can be two wireless transmission ICs having same standard/frequency or having different standards/frequencies, and both of them establishes their own wireless transmission channel respectively. It is to say, if the amount of the wireless transmission ICs 21 of the module 1 is two, the module 1 can use two wireless transmission channels at most. If the amount of the wireless transmission ICs 21 of the module 1 is three, the module 1 can use three wireless transmission channels at most, and so on. However, the above description is just a specific embodiment, not intended to limit the scope of the present invention.

The USB3.0 control IC 22 is electrically connected to the circuit board 2, and is further electrically connected with the plurality of wireless transmission ICs 21 through the circuit board 2. The USB3.0 control IC 22 integrates wireless signal received from the plurality of wireless transmission ICs 21 and outputs the integrated wireless signal externally. In the other hand, The USB3.0 control IC 22 receives signal from an electronic device (not shown) by way of a physical circuit, processes the received signal internally, and transmits the processed signal to the plurality of wireless transmission ICs 21 for wireless transmission.

In this embodiment, the amount of the plurality of wireless transmission ICs 21 is two, and the two wireless transmission ICs 211 and 212 establish different wireless transmission channels respectively via different frequencies. For example, the first wireless transmission IC 211 is a wireless transmission IC adopted 802.11n standard, and the second wireless transmission IC 212 is a wireless transmission IC adopted 802.11ac standard.

Generally, the 802.11n standard uses 2.4 GHz frequency band, and the 802.11ac standard uses 5 GHz frequency band. The two wireless transmission ICs 211 and 212 can establish their own channel respectively through different frequency bands. Therefore, the module 1 can transmits/receives wireless signal through more than one wireless transmission channel at the same time by way of the two wireless transmission ICs 211 and 212.

The reference transmission speed of the 802.11n standard is 300 Mbps, and the reference transmission speed of the 802.11ac standard is 867 Mbps. If the module 1 uses the wireless transmission IC 21 adopted the 802.11ac standard, and connects with an electronic device (not shown) via a USB2.0 interface, then the transmission speed of the 802.11ac standard will be limited at 480 Mbps because of the USB2.0 interface between the module 1 and the electronic device. In particularly, although the module 1 can transmit/receive wireless signal in 867 Mbps via the wireless transmission IC 21 adopted the 802.11ac standard, but the wireless signal is transmitted to the electronic device only in 480 Mbps through the USB2.0 interface. Therefore, the actual transmission speed of the module 1 is limited under 480 Mbps. The above description shows that the USB2.0 interface fails to satisfy the user demand about transmission speed of wireless transmission interface in these days, and the USB2.0 interface also fails to support two or more than two wireless transmission channels.

The USB3.0 control IC 22 of the present invention integrates wireless signal received from the two wireless transmission ICs 21. Based on the 5 Gbps transmission speed of USB3.0 standard, the USB3.0 control IC 22 has the ability to satisfy the highest transmission speed of the 8102.11ac standard, and also can support the plurality of wireless transmission ICs 21 for integrating and processing wireless signal from different wireless transmission channels at the same time.

As shown in FIG. 2 and FIG. 3, the transmission antenna 24 is electrically connected with the plurality of wireless transmission ICs 21 through the circuit board 2. In FIG. 3, the amount of the transmission antenna 24 is depicted as one, and the transmission antenna 24 is electrically connected to all of the plurality of wireless transmission ICs 21 for raising signal strength of the plurality of wireless transmission ICs 21.

FIG. 4 is a block diagram of a second embodiment according to the present invention. In this embodiment, the amount of the transmission antenna 24 is according to that of the plurality of wireless transmission ICs 21. As shown in FIG. 4, the plurality of wireless transmission ICs 21 includes the first wireless transmission IC 211 and the second wireless transmission IC 212, and the above mentioned transmission antennas 24 includes a first transmission antenna 241 and a second transmission antenna 242 according to the two wireless transmission ICs 211 and 212. The first transmission antenna 241 is electrically connected with the first wireless transmission IC 211 through the circuit board 2, and the second transmission antenna 242 is electrically connected with the second wireless transmission IC 212 through the circuit board 2. Therefore, the two wireless transmission ICs 211 and 212 can transmit/receive wireless signal respectively through their own connected transmission antenna 241 and 242, so as to reduce probable signal interference.

It should be mentioned is the transmission antenna 24 is depicted as a planar inverted F antenna (PIFA) for instance in FIG. 1, and the transmission antenna 24 is mainly arranged at two sides on one end of the circuit board 2, but not intended to limit the scope of the present invention.

The module 1 further includes a top cover 251 and a bottom cover 252. The circuit board 2, the plurality of wireless transmission ICs 21, the USB3.0 control IC 22 and the transmission port 23 are encapsulated in the top cover 251 and the bottom cover 252. Furthermore, the transmission antenna 24 is encapsulated in the top cover 251 and the bottom cover 252 if it is a PIFA and arranged on the circuit board 2 as mentioned above.

The transmission port 23 is electrically connected to the circuit board 2, and is further electrically connected with the USB3.0 control IC 22 through the circuit board 2. In the present invention, the module 1 is electrically connected with the external electronic device via the transmission port 23. Signal after being integrated by the USB3.0 control IC 22 is then transmitted from the module 1 to the electronic device through the transmission port 23. Further, the module 1 also receives signal from the electronic device through the transmission port 23, the USB3.0 control IC 22 processes the signal received from the electronic device, and transmits the processed signal externally and wirelessly through the plurality of wireless transmission ICs 21 and the transmission antenna 24.

In this embodiment, the transmission port 23 is depicted as a plurality of transmission terminals, one end of each of the plurality of transmission terminals is electrically connected to the circuit board 2, and the other end of each of the plurality of transmission terminals is extended out of the bottom cover 252 and being electrically connected with an external electronic device. The amount of the plurality of transmission terminals in this embodiment is according to the USB3.0 interface, which is depicted as nine.

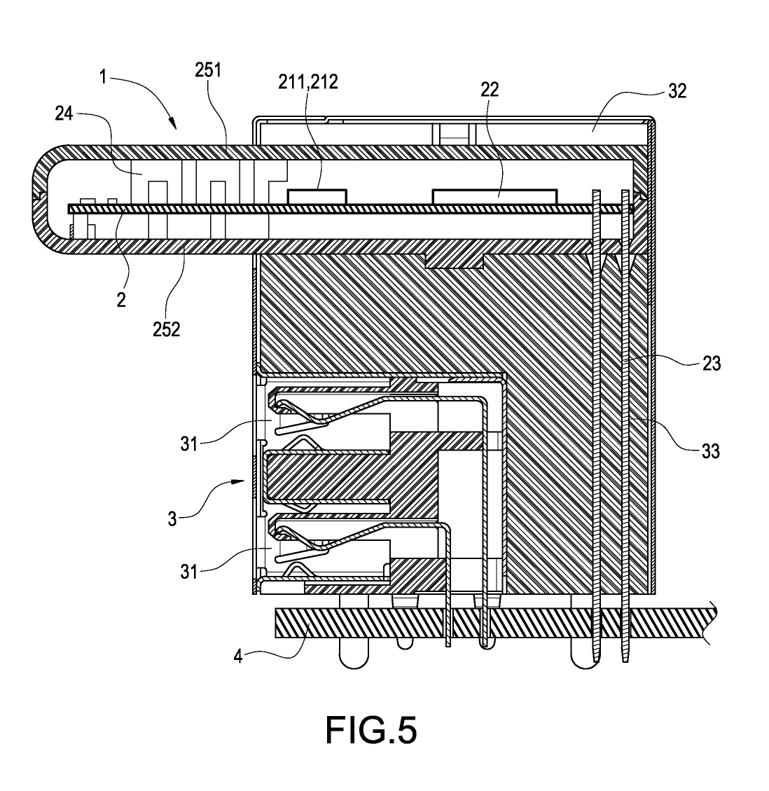

FIG. 5 is a perspective view showing a connection of a third embodiment according to the present invention. The module 1 is electrically connected to a mainboard 4 of the electronic device directly through the transmission port 23. Else, the module 1 can be arranged on a stacking connector 3. As shown in FIG. 5, the stacking connector 3 is electrically connected to the mainboard 4 directly, so the electronic device having the mainboard 4 can use the functions of the module 1 on the stacking connector 3.

The stacking connector 3 mainly includes at least one USB connector 31, a containing area 32 and a plurality of terminal slots 33. The containing area 32 is set on a top side of the stacking connector 3. The amount of the plurality of terminal slots 33 is according to that of the transmission terminals of the transmission port 23. The module 1 is arranged on the containing area 32, the nine transmission terminals of the transmission port 23 pass through the plurality of terminal slots 33, and each of the nine transmission terminals is extended out of a bottom side of the stacking connector 3. Therefore, the transmission port 23 can be electrically connected to the mainboard 4 directly, and the electronic device having the mainboard 4 can use the multiple wireless transmission channels of the module 1 to transmit/receive wireless signal.

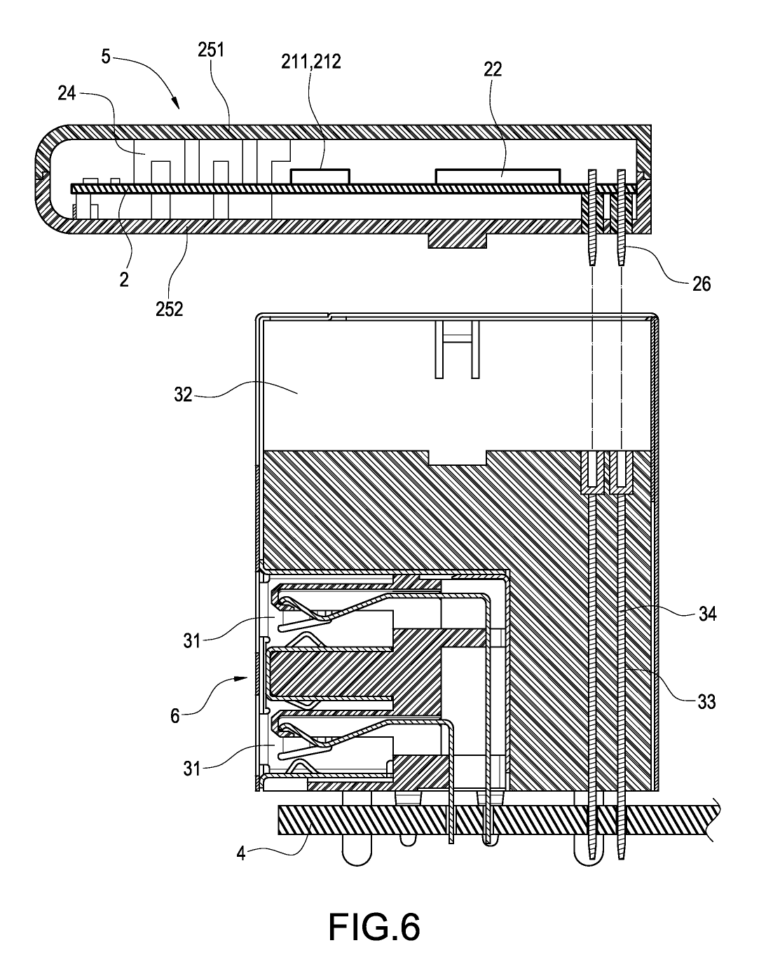

FIG. 6 is a perspective view showing a connection of a fourth embodiment according to the present invention. This embodiment discloses a second type wireless transmission module 5 (referred to as the module 5 hereinafter) and a second type stacking connector 6. The module 5 in this embodiment has the transmission port 23 which comprises nine pins 26. One end of each of the nine pins 26 is electrically connected to the circuit board 2 respectively, and the other end of each of the nine pins 26 is extended out of the bottom cover 252.

The stacking connector 6 arranges a plurality of pin sockets 34 in the plurality of terminal slots 33, the position and the amount of the plurality of pin sockets 34 are according to the position and the amount of the plurality of pins 26. A socket connector of each of the plurality of pin sockets 34 is exposed out of the containing area 32, and the other end away from the socket connector of each of the plurality of pin sockets 34 is extended out of a bottom side of the stacking connector 6 and being electrically connected to the mainboard 4. Therefore, the module 5 can electrically connect with the plurality of pin sockets 34 through the plurality of pins 26 when being arranged in the containing area 32, so as to electrically connect to the mainboard 4 through the plurality of pins 26 and pin sockets 34.

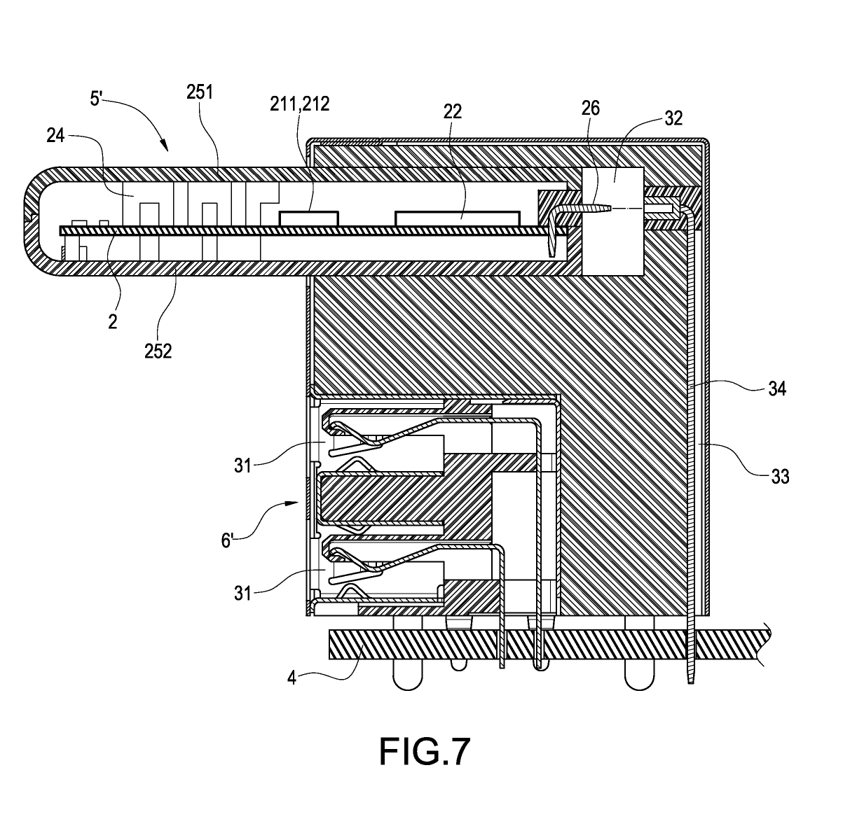

FIG. 7 is a perspective view showing a connection of a fifth embodiment according to the present invention. This embodiment discloses a third type wireless transmission module 5′ (referred to as the module 5′ hereinafter) and a third type stacking connector 6′. The difference between the above module 5 and the module 5′ is one end of each of the plurality of pins 26 of the module 5′ is extended out of a rear end of the top cover 251 and/or the bottom cover 252. Further, the socket connector of each of the plurality of pin sockets 34 of the stacking connector 6′ is extended out of the containing area 32 and bended frontward, and the bended socket connectors are parallel with the containing area 32. Therefore, the module 5′ can be inserted into the containing area 32 of the stacking connector 6′ from a front end of the stacking connector 6′, and each of the plurality of pins 26 of the module 5′ can be inserted into a corresponding pin socket 34 of the stacking connector 6′ and electrically connected with each other.

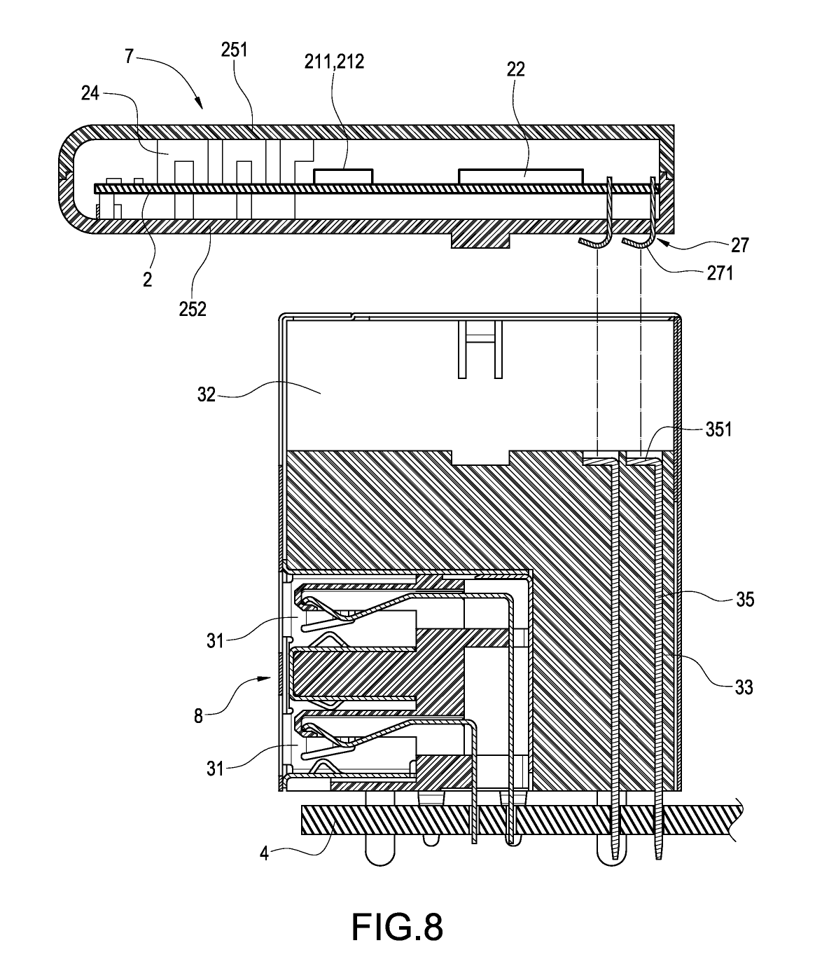

FIG. 8 is a perspective view showing a connection of a sixth embodiment according to the present invention. This embodiment discloses a fourth type wireless transmission module 7 (referred to as the module 7 hereinafter) and a fourth type stacking connector 8. The difference between the module 7 and other modules disclosed in above embodiments is the module 7 in this embodiment has the transmission port 23 which comprises nine abutting pieces 27. As shown in FIG. 8, one end of each of the plurality of abutting pieces is electrically connected to the circuit board 2, and the other end of each of the plurality of abutting pieces is bended inward to constitute an abutting portion 271. Each of the plurality of abutting portions 271 is exposed out of the bottom side of the bottom cover 252.

The stacking connector 8 arranges a plurality of conductive terminals 35 in the plurality of terminal slots 33, the position and the amount of the conductive terminals 35 are according to the position and the amount of the nine abutting pieces 27. In this embodiment, one end of each of the plurality of conductive terminals 35 is extended out of a bottom side of the stacking connector 8 for electrically connecting to the mainboard 4, the other end of each of the plurality of conductive terminals 35 is extended out of the containing area 32 and bended inward to constitute a conductive portion 351, and the plurality of conductive portions 351 are parallel with the containing area 32. As shown in FIG. 8, when being arranged in the containing area 32, the module 7 can electrically connect to the plurality of conductive portions 351 through the plurality of exposed abutting portions 271. Therefore, the module 7 can electrically connect with the mainboard 4 through the plurality of abutting pieces 27 and the plurality of conductive terminals 35.

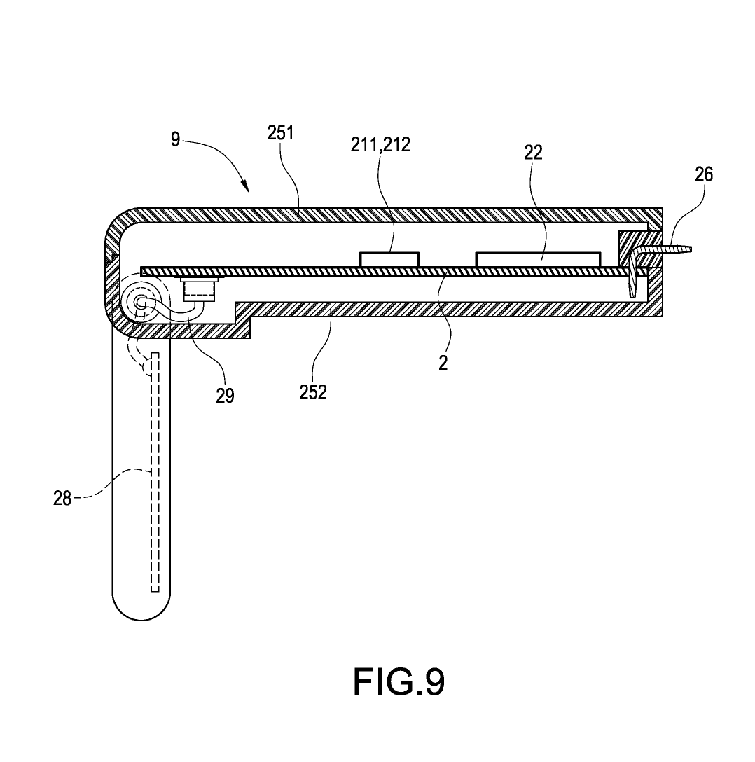

In above embodiments, the transmission antenna 24 is depicted as a PIFA for example, and the PIFA is encapsulated in the top cover 251 and the bottom cover 252. FIG. 9 is a side view of a seventh embodiment according to the present invention. This embodiment discloses a fifth type wireless transmission module 9 (referred to as the module 9 hereinafter), the module 9 has the transmission antenna 24 which is a board antenna 28. As shown in FIG. 9, the board antenna 28 is jointed with one side of the top cover 251 and/or the bottom cover 252. In particularly, the board antenna 28 is arranged out of the top cover 251 and the bottom cover 252, and not being encapsulated in the top cover 251 and the bottom cover 252.

The module 9 further includes a cable 29, which is electrically connected to the circuit board 2 and the board antenna 28 respectively by two ends of the cable 29. The plurality of wireless transmission ICs 21 of the module 9 is electrically connected to the board antenna 28 through the cable 29, so as to raise the signal strength of wireless transmission through the board antenna 28.

The wireless transmission module in the present invention integrates wireless signal from multiple wireless transmission ICs 21 by the USB 3.0 control IC 22, so an electronic device can use the multiple wireless transmission channels supported by the wireless transmission module when the wireless transmission module is connected with the electronic device. Therefore, the electronic device having the wireless transmission module can raise transmission rate, or reach the purpose of multi-transmission capability.

In other words, the electronic device having the wireless transmission module can accomplish wireless transmission function which needs big bandwidth. For example, wireless display (Wi-Di) is a new technology which can output big amount of multimedia signal (for example, Full HD image) via network from an electronic device to an external display to display synchronously. However, data quantity of multimedia signal is enormous, so the transmission of the multimedia signal will occupy most of network bandwidth, the external display can't receive and display the multimedia signal smoothly. However, if the electronic device above is arranged the wireless transmission module disclosed in the present invention, it can transmit the above multimedia signal through multiple wireless transmission channels, so the external display can receive and display the multimedia signal smoothly.

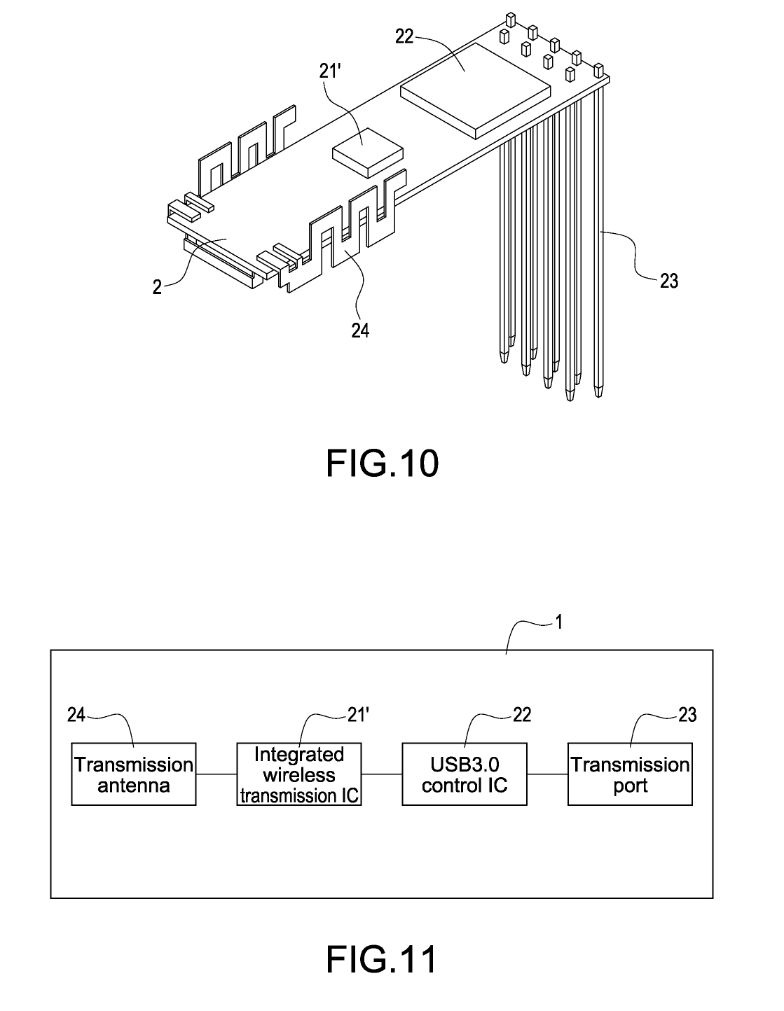

FIG. 10 is a combination perspective view of an eighth embodiment according to the present invention. FIG. 11 is a block diagram of a ninth embodiment according to the present invention. In this embodiment of FIG. 10 and FIG. 11, the first wireless transmission IC 211 and the second wireless transmission IC 212 mentioned above can be integrated into an integrated wireless transmission IC 21′. In other words, the integrated wireless transmission IC 21′ can support both of the 802.11n standard and the 802.11ac standard at the same time, and establish two or more than two wireless transmission channels through only one transmission antenna 24 or multiple transmission antennas 24.

Although the present invention has been described with reference to the foregoing preferred embodiments, it will be understood that the invention is not limited to the description thereof. Any equivalent variations and modifications can be made to those skilled in the art in view of the teaching of the present invention are also in the scope of the invention as defined in the appended claims.

What is claimed is:

1. A wireless transmission module, comprising:
a circuit board;
at least one wireless transmission integrated circuit (IC) electrically connected to the circuit board, the at least one wireless transmission IC establishing at least two wireless transmission channels;
a USB3.0 control integrated circuit (IC) electrically connected to the circuit board, and further electrically connected with the at least one wireless transmission IC through the circuit board, the USB3.0 control IC integrating wireless signal received by the at least one wireless transmission IC;
a transmission antenna electrically connected to the circuit board, and further electrically connected with the at least one wireless transmission IC through the circuit board; and
a transmission port electrically connected to the circuit board, and further electrically connected to the USB3.0 control IC through the circuit board;
wherein, the wireless transmission module connects to an external electronic device through the transmission port for transmitting signal integrated by the USB3.0 control IC externally to the external electronic device and receiving signal from the electronic device to transmit to the USB3.0 control IC for processing.

2. The wireless transmission module according to claim 1, wherein the at least one wireless transmission IC includes two wireless transmission ICs having different standard, and the two wireless transmission ICs establish different wireless transmission channels respectively.

3. The wireless transmission module according to claim 2, wherein one of the two wireless transmission ICs adopts 802.11n standard, and the other one of the two wireless transmission ICs adopts 802.11ac standard.

4. The wireless transmission module according to claim 3, wherein the two wireless transmission ICs are integrated into a single integrated wireless transmission IC.

5. The wireless transmission module according to claim 3, further comprising a top cover and a bottom cover, and the circuit board, the plurality of wireless transmission ICs, the USB3.0 control IC and the transmission port are encapsulated in the top cover and the bottom cover.

6. The wireless transmission module according to claim 5, wherein the transmission port comprises nine transmission terminals, one end of each of the nine transmission terminals is electrically connected to the circuit board separately, and the other end of each of the nine transmission terminals is extended out of a bottom side of the bottom cover.

7. The wireless transmission module according to claim 5, wherein the transmission port comprises nine pins, one end of each of the nine pins is electrically connected to the circuit board separately, and the other end of each of the nine pins is extended out of the bottom cover.

8. The wireless transmission module according to claim 5, wherein the transmission port comprises nine abutting pieces, one end of each of the nine abutting pieces is electrically connected to the circuit board, and the other of each of the nine abutting pieces is bended inward to constitute a abutting portion, and each of the plurality of abutting portions is extended out of a bottom side of the bottom cover separately.

9. The wireless transmission module according to claim 5, wherein the transmission antenna is a board antenna, the board antenna is jointed to one side of the top cover and the bottom cover, and the wireless transmission module further includes a cable electrically connected to the circuit board and the board antenna, and the plurality of wireless transmission ICs are electrically connected to the board antenna through the circuit board and the cable.

10. The wireless transmission module according to claim 5, wherein the transmission antenna is a planar inverted F antenna (PIFA), the PIFA is arranged on two sides of one end of the circuit board, and the PIFA is encapsulated in the top cover and the bottom cover.
